(19) United States
(12) Patent Application Publication
(10) Pub. No.: US 2006/0139177 A1
(43) Pub. Date: Jun. 29, 2006

(54) Low oil level indicator

(76) Inventor: Victor E. Gomery, Cosmopolis, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 11/301,827

(22) Filed: Dec. 12, 2005

Related U.S. Application Data
(60) Provisional application No. 60/635,871, filed on Dec. 13, 2004.

(51) Int. Cl. G08B 21/00; B60Q 1/00

(52) U.S. Cl. 340/624; 340/450.3

(57) ABSTRACT

A self powered low oil level indicator. The device includes a dipstick extending downward from a cap, and it replaces stock oil reservoir caps on mechanical devices which have oil reservoirs and in some cases have oil fill tubes. The indicator dipstick has a first end, a second end, and a longitudinal axis. An electrical circuit is provided including electrical conductors, a battery, an indicating light, and a switch having an electrically conductive on-off element. A float configured for carriage of the electrically conductive on-off element is provided at or near the lower end of the dipstick. When the float displacement is lowered by low oil level, the electrical circuit is completed, allowing the battery to energize a warning light.

### TECHNICAL FIELD

This invention relates to the field of oil level gauges and indicators, and especially, to oil level gauges and indicators for power tools and equipment.

### BACKGROUND

Oil level indicators and gauges have been used for many years, and various versions have long provided their unique attributes for various tasks where it was desired to determine the oil level in a particular piece of mechanical equipment such as a motor vehicle engine. In various oil gauge designs, the use of a float has been adapted to include a way to provide an indication of low oil level to the user of the vehicle, with electrical power supplied to the gauge by the electrical system of the vehicle. And, a device which is configured to mount in the dipstick holder of an automobile was disclosed in U.S. Pat. No. 4,034,608, issued Jul. 12, 1977 to Vincent; however, that device was powered by connection to a conventional automotive electrical battery.

In many mechanical devices having an oil sump, the devices are operated remotely from a convenient external electrical supply, yet the device does not generate on-board power or carry on-board battery power. One common example of such as device in everyday use is the typical push-type lawn mower. Although a magneto device is utilized to generate an electrical spark to fire many such engines, one reason for the lack of oil indicators in such devices may be the lack of an on-board electrical power supply system, so that conventional prior art oil gauges may be employed. Unfortunately, many small mechanical devices such as pumps, compressors, and engines, and particularly lawn mower engines, suffer catastrophic failure due to the lack of lubrication. Such failures could be easily prevented if the operator of the device were made aware that the device needed oil, provided that such need was brought to the operator's attention in a timely manner.

Importantly, it would be a distinct and important improvement to provide an oil level indicator which is quickly and easily secured to existing mechanical devices through existing ports such as oil addition tubes. Moreover, it would be desirable to provide a design which can be quickly installed in the place of existing oil caps, thus allowing the oil level device to be easily installed yet which maintains the ease of service and oil addition. Thus, the important advantages of an oil indicating device providing such desirable features in a workable motor or engine apparatus can be readily appreciated.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

FIG. 1 is a perspective view of a low oil level indicator as taught herein installed in a normal working position through the oil addition port in a conventional push-type lawn mower.

FIG. 2 is a perspective view of an exemplary embodiment of a low oil level indicator, showing an elongated dip-stick downwardly extending from a cap, an indicator light, a battery for supply of electrical power, and a see-through cap which may be configured for retention of the battery as well as visibility of the light.

FIG. 3 is a cross-sectional view of a low oil level indicator, showing the device as if installed in an oil fill tube instead of a standard oil dipstick and cover, and wherein the oil level is sufficiently high that the electrical circuit is broken by upward displacement of the float and its electrical contacts.

FIG. 4 is a cross-sectional view of the low oil level indicator just set forth in FIG. 3, but now showing the device in operation when the oil level is low, and the electrical circuit is completed by the electrical contacts operatively connected to the float.

FIG. 5 is a schematic view of a typical self contained electrical system for powering a low oil level indicator for use with such devices having no external connection to electrical power.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, various other elements of the low oil level indicator device, especially as applied for different variations and adaptations for fitting into a variety of oil fill pipes, as well as different embodiments of artistic elements such as handle design, may be utilized in order to provide a robust low oil level indicator with easy hand operated cap design.

### DETAILED DESCRIPTION

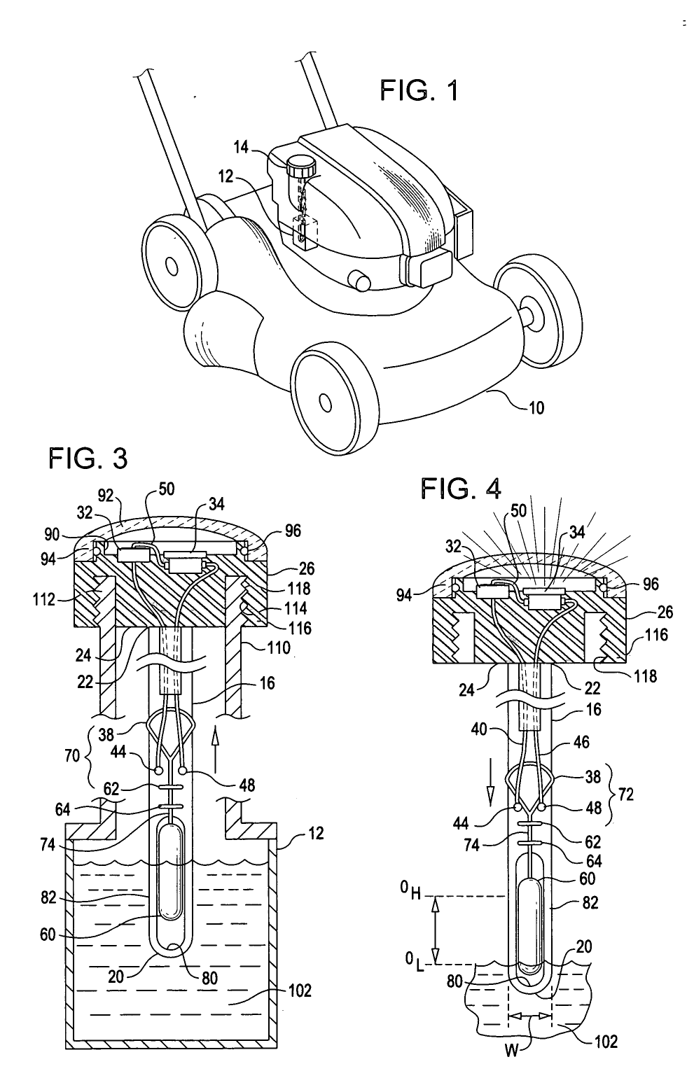

Turning now to FIG. 1, a mechanical device such as a lawn mower 10 having an oil sump 12 is illustrated with a low oil level indicator 14 as taught herein installed. Although the device is described with respect to use in a lawn mower, it is equally adaptable to and useful for a wide variety of mechanical devices, such as pumps, compressors, or other devices which have an oil reservoir-and are without an on-board or other nearby convenient source of electrical power. Additionally, the low oil level device as taught herein can be applied in other mechanical devices which would benefit from having an operator observable low oil level indicator independent from on-board power, including, for example, under hood application in motor vehicles, or on recreational vehicles.

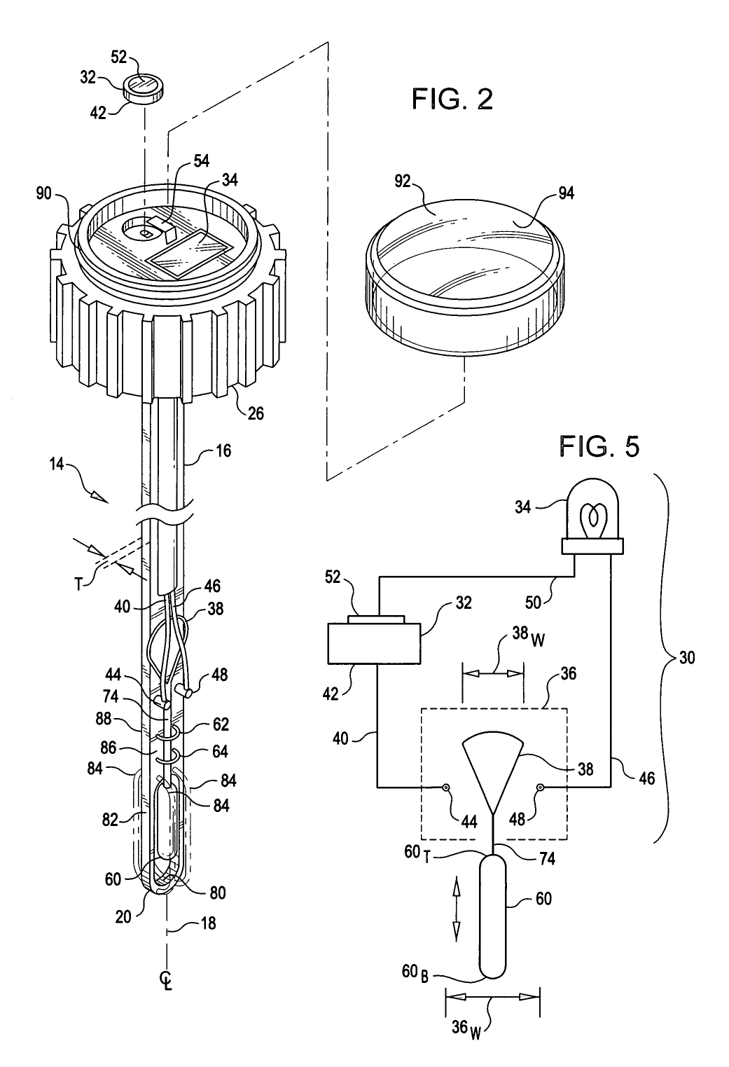

Details of my low oil level indicator 14 can be better appreciated by reference to FIGS. 2 and 3. An elongated dipstick 16 of any convenient size, such as having a width W of about 0.5 inches in one embodiment, and a thickness T of about 0.125 inches and a length L of suitable size with respect to an oil reservoir in which it is to be inserted, is provided along a longitudinal axis 18 indicated by centerline C_{L} in FIG. 2. The dipstick 16 has a first or lower end 20, and a second or upper end 22. The second or upper end 22 of dipstick 16 is affixed to a lower interior portion 24 of cap 26, so that dipstick 16 extends downwardly from the cap 26.

An electrical circuit 30 is provided as indicated in FIG. 5. A battery 32, indicating light 34, and a switch 36 having an electrically conductive on-off element 38 are provided. The electrical circuit 30 includes suitable electrical conductors, such as first conductor 40 between a first pole 42 of the battery 32 and a first contact pin 44, a second conductor 46 between second contact pin 48 and the light 34, and a third conductor 50 between the lamp 34 and a second pole 52 of battery 32. In conventional fashion any one of the conductors 40, 46, or 50 may be provided with one or more components or sections, including for example in conductor 40, a leaf type battery contact 54 as shown in FIG. 2.

In one embodiment, a float 60 is configured for carriage of the electrically conductive on-off element 38 along the longitudinal axis 18 of dipstick 16. The float 60 is operatively secured by retainers 62 and 64 at or near the first or lower end 20 of the elongated dipstick 16, for displaceable movement between a first position 70 as shown in FIG. 3 wherein the electrical circuit 30 is switched off, and a second position 72 as shown in FIG. 4 wherein the electrical circuit 30 is switched on, so that light 34 is illuminated.

In one embodiment as see in FIGS. 2, 3, and 4, float 60 can be provided in an elongated tubular configuration having sealed generally dome shaped top and bottom ends 60_{T} and 60_{B}, respectively, and an extension arm support 74 to secure the electrically conductive element 38 above the float 60. In one embodiment, the extension arm support 74 and the electrically conductive element 38 may be provided integrally constructed using the same material, such as strong, stiff, conductive metallic wire. The float 60 may be manufactured in sealed hollow glass or other suitable material. When a breakable material such as glass is utilized, a caging structure defined at least in part by an elongated oval interior wall 80 in the lower portion 82 of dipstick 16, near the bottom end 20. For additional protection, one or more cage members 84 may be provided, which in one embodiment as indicated in FIG. 2, may be oriented perpendicular to the minor axis of oval interior wall 80 and affixed to dipstick 16 in a generally C-shaped configuration. Two cage members 84 on each of first 86 and second 88 sides of dipstick 16 may be provided as indicated in FIG. 2.

In one embodiment as illustrated herein, the low oil level indicator 14 includes a cap 26 which has an upper mounting flange 90. An at least partially transparent (to at least visible light) and preferably replaceably detachable cover 92 is provided. The cover 92 may include generally a downwardly directed mounting flange 94. The downwardly directed mounting flange 94 is configured for secure mating engagement with the upper mounting flange 90 of cap 26. In the embodiment indicated in FIG. 2, the cover 92 is generally circular with an interference fit 96 downwardly directed peripheral mounting flange, and wherein said upper mounting flange on said cap is provided in complementary shape to the interference fit cap, so that the cap and cover are secured together. Alternately, threaded construction of upwardly directed mounting flange 90 and downwardly directed mounting flanges 94 may be provided, and in such case, the cover 92 may be secured to cap 26 by threaded engagement. In any event, the provision of a replaceably detachably cover 92 which covers the battery 32 makes the battery 32 replaceable. In one embodiment, the cover 92 secures tab 54 against pole 52 of battery 32 to complete that portion of the electrical circuit 30.

As can be seen by comparison between FIGS. 3 and 4, the float 60 of the low oil level indicator 14 is displacebly situated along the longitudinal axis of the dipstick 16 so that the electrical circuit 30 (a) is switched off by the rise of said float 60 toward the cap 26, such as level O_{H} as indicated in FIG. 4, and (b) is switched on by the fall of the float 60 away from the cap 26, to a level such as level O_{L} as indicated in FIG. 4, wherein the electrically conductive on-off element 38 of the switch 36 completes electrical circuit 30 to energize the indicating light 34. The just described mechanism is facilitated by the buoyancy of float 60 in oil 102 in oil reservoir 12. As shown generally herein, one useful embodiment has been developed wherein the electrically conductive on-off element 38 is formed in a wire loop shape, and wherein the wire loop is sized and shaped with sufficient width 38_{W} to rest on said first and second contact pins having a width therebetween of 36_{W}, when the float 60 level drops to a preselected position O_{L} indicating low level of oil 102 in a selected mechanical device, so that when loop of electrically conductive element 38 rests on the first 44 and second 48 pins, to complete the electrical circuit 30.

I have found that a useful device for light 34 is a light emitting diode. For most low oil level indicators, emission of a red light when light 34 is energized is normally appropriate.

In any mechanical device, such as a lawn mower 10, the low oil level indicator 14 must e securely affixed to the oil reservoir 12. Many mechanical devices include an oil fill tube 110 having an upper end 112 with threaded 114 connections. In such a case, the lower flanges 116 of cap 26 are provided with threads 118 of complementary dimensions for secure mating threaded engagement.

It is to be appreciated that the various aspects and embodiments of a low oil level indicator device as described herein are an important improvement in the state of the art. The low oil level indicator device is simple, robust, reliable, and useable in a variety of applications. Although only a few exemplary embodiments have been described in detail, various details are sufficiently set forth in the drawings and in the specification provided herein to enable one of ordinary skill in the art to make and use the invention(s), which need not be further described by additional writing in this detailed description.

Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings.

1. An oil level indicator, comprising:
an elongated dipstick member having a first end, a second end, and a longitudinal axis;
a cap, said cap secured to said second end of said dipstick;
an electrical circuit, said electrical circuit comprising electrical conductors, a cap mounted battery, an indicating light, and a switch having an electrically conductive on-off element;
a float, said float configured for carriage of said electrically conductive on-off element, said float operatively secured at or near said first end of said elongated dipstick for displaceable movement between a first position wherein said electrical circuit is switched off, and a second position wherein said electrical circuit is switched on.

2. The oil level indicator as set forth in claim 1, wherein said float is secured for movement along said longitudinal axis of said dipstick.

3. The oil level indicator as set forth in claim 1, further comprising a light transmissible cover attached to said cap.

4. The oil level indicator as set forth in claim 3, wherein said cap comprises an upper mounting flange, and wherein said cover comprises a generally downwardly directed mounting flange, and wherein said downwardly directed mounting flange is configured for secure mating engagement with said upper mounting flange.

5. The oil level indicator as set forth in claim 4, wherein said cover is generally circular with a downwardly directed peripheral mounting flange, and wherein said cap and said cover are secured together by (a) interference fit, or (b) threaded engagement.

6. The oil level indicator as set forth in claim 1, wherein said cap comprises a downwardly extending perimeter flange.

7. The oil level indicator as set forth in claim 6, wherein said downwardly extending perimeter flange is threaded.

8. The oil level indicator as set forth in claim 1, wherein said float comprises a sealed hollow glass structure.

9. The oil level indicator as set forth in claim 8, wherein said sealed hollow glass structure is provided in an elongated tube shape having an upper end, and wherein the longitudinal axis of said elongated tube shape is oriented along said longitudinal axis of said dipstick.

10. The oil level indicator as set forth in claim 9, wherein said electrically conductive on-off element is supported above said upper end of said elongated tube shape.

11. The device as set forth in claim 10, wherein said electrically conductive on-off element is supported above said upper end of said elongated tube shape by an extension arm from said electrically conductive on-off element.

12. The device as set forth in claim 11, wherein said arm and said electrically conductive on-off element are integrally formed from the same composition of metallic material.

13. The oil level indicator as set forth in claim 10, wherein said switch in said electrical circuit further comprises first and second contact pins, and wherein said electrically conductive on-off element is displacebly situated along said longitudinal axis of said dipstick so that said electrical circuit is switched off by the rise of said float toward said cap or on by the fall of said float away from said cap, and in the latter case, wherein said electrically conductive on-off element of said switch completes an electrical circuit to energize said indicating light.

14. The device as set forth in claim 13, wherein said electrically conductive on-off element comprises a wire loop, said loop sized and shaped to rest on said first and second contact pins when said float level drops to a preselected position indicating low oil level in a selected device, and when resting on said first and second pins, to complete an electrical circuit therebetween.

15. The oil level indicator as set forth in claim 1, wherein said indicator light comprises a light emitting diode.

16. The device as set forth in claim 15, wherein said light emitting diode emits a red light when energized.

17. An article of manufacture comprising:
a lawn mower, said lawn mower comprising an engine having an oil fill tube having an upper end and a low oil level indicator sized and shaped for secure mating engagement with said oil fill tube, said low oil level indicator comprising
a cap, said cap secured to said upper end of said oil fill tube, said cap having a central interior portion;
an elongated dipstick having a first end, a second end, and a longitudinal axis, said second end of said elongated dipstick affixed to said central interior portion of said cap and extending downwardly therefrom;
an electrical circuit, said electrical circuit comprising electrical conductors, a cap mounted battery, an indicating light, and a switch having an electrically conductive on-off element;
a float, said float configured for carriage of said electrically conductive on-off element, said float operatively secured at or near said first end of said elongated dipstick for displaceable movement between a first position wherein said electrical circuit is switched off, and a second position wherein said electrical circuit is switched on.

18. An article of manufacture comprising:
a mechanical device having an oil reservoir and an oil fill tube, said oil fill tube having an upper end and a low oil level indicator sized and shaped for secure mating engagement with said oil fill tube, said low oil level indicator comprising
a cap, said cap secured to said upper end of said oil fill tube, said cap having a central interior portion;
an elongated dipstick having a first end, a second end, and a longitudinal axis, said second end of said elongated dipstick affixed to said central interior portion of said cap and extending downwardly therefrom;
an electrical circuit, said electrical circuit comprising electrical conductors, a cap mounted battery, an indicating light, and a switch having an electrically conductive on-off element;
a float, said float configured for carriage of said electrically conductive on-off element, said float operatively secured at or near said first end of said elongated dipstick for displaceable movement between a first position wherein said electrical circuit is switched off, and a second position wherein said electrical circuit is switched on.

19. The apparatus as set forth in claim 17 or in claim 18, wherein said switch in said electrical circuit further comprises first and second contact pins, and wherein said electrically conductive on-off element is displacebly situated along said longitudinal axis of said dipstick so that said electrical circuit is switched off by the rise of said float toward said cap or on by the fall of said float away from said cap, and in the latter case, wherein said electrically conductive on-off element of said switch completes an electrical circuit to energize said indicating light.

20. The apparatus as set forth in claim 19, wherein said electrically conductive on-off element comprises a wire loop, said loop sized and shaped to rest on said first and second contact pins when said float level drops to a preselected position indicating low oil level in a selected device, and when resting on said first and second pins, to complete an electrical circuit therebetween.

21. The apparatus as set forth in claim 17 or in claim 18, wherein said indicator light comprises a light emitting diode.

22. The apparatus as set forth in claim 15, wherein said light emitting diode emits a red light when energized.

23. The apparatus as set forth in claim 17 or in claim 18, wherein said cap further comprises a detachable cover which secures said battery to electrical conductors, and wherein said battery is accessible for replacement when said detachable cover is detached from said cap.

24. The apparatus as set forth in claim 23, wherein said detachable cover also covers said indicator light when said detachable cover is affixed to said cap, and wherein said detachable cover is optically transparent, so that light emitted by said indicator light is visible through said detachable cover.
